(19) United States
(12) Patent Application Publication
(10) Pub. No.: US 2026/0152446 A1
(43) Pub. Date: Jun. 4, 2026

(54) HOLLOW SPHERE AND METHOD FOR MANUFACTURING THE SAME

(71) Applicant: METAL INDUSTRIES RESEARCH AND DEVELOPMENT CENTRE, Kaohsiung (TW)

(72) Inventors: Chih-Wei LU, Kaohsiung (TW); Ho-Lin TSAI, Kaohsiung (TW); Shin-Hong KUO, Kaohsiung (TW); Chun-Han TSANG, Kaohsiung (TW)

(21) Appl. No.: 19/395,748

(22) Filed: Nov. 20, 2025

(30) Foreign Application Priority Data
Nov. 29, 2024 (TW) 113146393

(51) Int. Cl. C04B 38/00; C04B 35/14; C04B 35/624; C04B 35/626; C04B 35/64; C04B 38/06

(52) U.S. Cl. CPC C04B 38/009; C04B 35/14; C04B 35/624; C04B 35/62695; C04B 35/64; C04B 38/0045; C04B 38/06; C04B 2235/3217; C04B 2235/3244; C04B 2235/3418; C04B 2235/656; C04B 2235/765; C04B 2235/94; C04B 2235/95

(57) ABSTRACT

A method for manufacturing hollow spheres includes: mixing water, a slurry component including a binder, and a waste foundry sand including silicon dioxide, aluminium oxide and zirconium dioxide to form a slurry, the waste foundry sand being present in an amount ranging from 40 wt % to 60 wt % based on 100 wt % of the slurry; subjecting the slurry to granulation, so that the slurry is formed into solid granules; and subjecting the solid granules to a heat treatment, followed by cooling, so as to allow the solid granules to undergo a thermochemical reaction and to be converted into the hollow spheres, each of the hollow spheres having a ceramic shell that contains tetragonal zirconium dioxide. A hollow sphere manufactured by the aforesaid method is also provided.

### CROSS-REFERENCE TO RELATED APPLICATION

This application claims priority to Taiwanese Invention patent application No. 113146393, filed on Nov. 29, 2024, the entire disclosure of which is incorporated by reference herein.

### FIELD

The disclosure relates to a hollow sphere and a method for manufacturing the same.

### BACKGROUND

Hollow microspheres possess properties including lubrication, low density, light weight, thermal insulation, and sound insulation, and can be applied in fields such as oil well exploration, marine technology, aerospace, and construction. Manufacturing of the hollow microspheres typically involves techniques such as solid-state powder processing, spray granulation, sol-gel drying or droplet-based method, which allows microsphere formation. At times, waste materials are employed as feedstock for production of the hollow microspheres.

CN 108483930 A discloses a method for preparing hollow microspheres, in which solid waste, a modifier, a foaming agent and a flux are made into a powdery agglomerate, and subsequently, the powdery agglomerate is fed into a spray combustion device, where the aforesaid ingredients undergo a melting, an expansion and a rapid quenching processes, thereby producing inorganic hollow microspheres. The solid waste may consist of one or more of the following materials: waste glass, waste incineration bottom ash, waste incineration fly ash, bottom ash from coal combustion, fly ash from coal combustion, sewage treatment sludge, sediment from rivers, lakes and seas, steel slag, bottom ash from incinerated water treatment sludge, and waste activated carbon. The modifier may consist of one or more of the following materials: alumina, magnesium oxide, titanium dioxide, calcium silicate, calcium aluminosilicate, ethyl orthosilicate, sodium silicate, potassium silicate, and silicic acid. The foaming agent may consist of one or more of the following materials: calcium carbonate, silicon nitride, silicon carbide, and carbon black. The flux may consist of one or more of the following materials: lithium oxide, boron oxide, and silicon dioxide. Specifically, the aforementioned melting, expansion and rapid quenching processes are conducted to atomize the powdery agglomerate, and to allow the thus formed atomized agglomerate to burn and melt, and meanwhile, due to decomposition of the foaming agent, gas is generated in the thus obtained melted agglomerate, leading to expansion of the melted agglomerate, thereby forming molten hollow spheres. The molten hollow spheres are then cooled, causing surfaces thereof to rapidly solidify so as to form hollow microspheres.

In addition, CN 102826860 A discloses a method for preparing low-cost hollow spheres, which includes the following steps: A) placing molten or solid blast furnace slag in an electric arc furnace and then subjecting the same to a smelting treatment at a temperature ranging from 1400° C. to 1700° C.; B) subjecting the resultant molten blast furnace slag to a refining treatment at the aforesaid temperature for 5 minutes to 30 minutes; and C) tilting the electric arc furnace to pour the refined molten blast furnace slag therefrom, and blowing the refined molten blast furnace slag with compressed air or a high-temperature flame at an outlet of the electric arc furnace, thereby obtaining the low-cost hollow spheres. In the smelting treatment of step A), a carbon-containing material, an alkali metal compound, and/or an alkaline earth metal compound may further be added. The low-cost hollow spheres thus prepared have a composition comprising, by mass, 15% to 44.5% of CaO, 18% to 40.5% of SiO₂, 10.0% to 21.4% of Al₂O₃, and 2.0% to 14.5% of MgO.

A waste foundry sand, which is an industrial waste generated by the foundry industry, is difficult to be reused in the foundry production line, not easy to be regenerated, and is highly polluting. At present, the waste foundry sand is mostly disposed by landfill burial or storage in a purchased land, which incurs high cost and great harm to the environment. Consequently, finding a way to effectively manage and recycle the waste foundry sand has become an urgent issue to be solved in the foundry industry. In this regards, TW 201422820 A discloses a method for stabilizing steel slag, which includes, in the absence of a heat treatment, together adding a waste foundry sand, which serves as a glass-forming agent, and an alkali metal carbonate or an alkali metal oxide, which serves as a flux, to a molten steel slag, thereby transforming the molten steel slag that has an unstable property into a stable amorphous silicate material. Furthermore, in each of TW 201040126 A, TW 201109288 A, TW 202322931 A, and TW 202133956 A, utilization of a waste foundry sand to make a construction material is also disclosed.

In spite of the above, technology for producing hollow microspheres using a waste foundry sand as a raw material is not available.

### SUMMARY

Accordingly, in a first aspect, the present disclosure provides a method for manufacturing hollow spheres, which can alleviate at least one of the drawbacks of the prior art, and which includes:
mixing water, a slurry component including a binder, and a waste foundry sand including silicon dioxide, aluminium oxide, and zirconium dioxide to form a slurry, the waste foundry sand being present in an amount ranging from 40 wt % to 60 wt % based on 100 wt % of the slurry;
subjecting the slurry to granulation, so that the slurry is formed into solid granules; and
subjecting the solid granules to a heat treatment, followed by cooling, so as to allow the solid granules to undergo a thermochemical reaction and to be converted into the hollow spheres, each of the hollow spheres having a ceramic shell that contains tetragonal zirconium dioxide.

In a second aspect, the present disclosure provides a hollow sphere, which can alleviate at least one of the drawbacks of the prior art, and which is manufactured by the aforesaid method. The hollow sphere includes the silicon dioxide present in an amount ranging from 60 wt % to 75 wt %, the aluminium oxide present in an amount ranging from 15 wt % to 30 wt %, and the zirconium dioxide present in an amount ranging from 1 wt % to 10 wt %. The hollow sphere has the ceramic shell that contains the tetragonal zirconium dioxide.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 shows an optical microscope (OM) image of solid granules of the Example according to the present disclosure.

FIG. 2 shows a scanning electron microscope (SEM) image of the solid granules of the Example according to the present disclosure.

FIG. 3 shows SEM images of hollow spheres of the Example according to the present disclosure.

FIG. 4 shows an X-ray diffraction pattern illustrating ingredients of each of waste foundry sand and the hollow spheres of the Example according to the present disclosure.

### DETAILED DESCRIPTION

It is to be understood that, if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

The present disclosure provides a method for manufacturing hollow spheres, which includes:
mixing water, a slurry component including a binder, and a waste foundry sand including silicon dioxide, aluminium oxide and zirconium dioxide to form a slurry, the waste foundry sand being present in an amount ranging from 40 wt % to 60 wt % based on 100 wt % of the slurry;
subjecting the slurry to granulation, so that the slurry is formed into solid granules; and
subjecting the solid granules to a heat treatment, followed by cooling, so as to allow the solid granules to undergo a thermochemical reaction and to be converted into the hollow spheres, each of the hollow spheres having a ceramic shell that contains tetragonal zirconium dioxide.

Specifically, in the method for manufacturing the hollow spheres, the waste foundry sand is recycled and made into the hollow spheres of the present disclosure, which contain tetragonal zirconium dioxide, thus enabling the hollow spheres to withstand high temperatures.

In some embodiments, the slurry component may include the binder, a dispersing agent and a thickener. In still some embodiments, in the method of the present disclosure, initially, the water, the slurry component including the binder, the dispersing agent and the thickener, and the waste foundry sand including the silicon dioxide, the aluminium oxide and the zirconium dioxide are mixed to form the slurry.

According to the present disclosure, the waste foundry sand is an industrial waste of foundry industries, and may originate from sources such as a ceramic shell molding sand, a phenolic resin sand, a green sand, a water glass sand, and a furan sand. In some embodiments, the waste foundry sand may be obtained through the following steps: sequentially crushing, calcining, grinding, and sieving a discarded shell mold, so as to obtain the waste foundry sand having an average particle size of less than 53 μm. The waste foundry sand thus obtained may contain mullite, zircon, cristobalite, quartz, monoclinic zirconium dioxide (m-ZrO₂), and tetragonal zirconium dioxide (t-ZrO₂). Additionally, contents of components in the waste foundry sand can be selectively adjusted. In some embodiments, based on 100 wt % of the waste foundry sand, the zirconium dioxide may be present in an amount ranging from 1 wt % to 10 wt %, the silicon dioxide may be present in an amount ranging from 50 wt % to 70 wt %, and the aluminium oxide may be present in an amount ranging from 20 wt % to 40 wt %. In still some embodiments, based on 100 wt % of the waste foundry sand, the zirconium dioxide may be present in an amount ranging from 1 wt % to 10 wt %, the silicon dioxide may be present in an amount ranging from 50 wt % to 70 wt %, the aluminium oxide may be present in an amount ranging from 20 wt % to 40 wt %, and other metal oxide(s) may be present in an amount ranging from 5 wt % to 10 wt %. Due to a temperature change that occurs in a heat treatment subsequently conducted, the zirconium dioxide will undergo a phase transformation to form the tetragonal zirconium dioxide, which is a special crystal phase of the zirconium dioxide. In particular, when the zirconium dioxide is present in the aforesaid amount (i.e., 1 wt % to 10 wt %), the hollow spheres obtained by the method of the present disclosure contain more of the tetragonal zirconium dioxide, thus rendering the hollow spheres more resistant to high temperatures. When the silicon dioxide is present in the aforesaid amount (i.e., 50 wt % to 70 wt %), the hollow spheres thus obtained show a relatively high strength. When the aluminium oxide is present in the aforesaid amount (i.e., 20 wt % to 40 wt %), the hollow spheres thus obtained have improved tolerance to temperature variation.

According to the present disclosure, the type of the binder is not limited, and can be flexibly adjusted according to actual silicon and aluminum contents in the waste foundry sand. In some embodiments, the binder may be selected from the group consisting of a silica gel, a silicone resin, and a combination thereof. When the combination of the silica gel and the silicone resin is used to serve as the binder, a ratio of the silica gel and the silicone resin may be adjusted according to actual needs. An example of the dispersing agent may be, but is not limited to, an aqueous dispersing agent. An example of the thickener may be, but is not limited to, methylcellulose.

In some embodiment, the slurry is prepared by mixing the water, a first aqueous solution containing the binder, a second aqueous solution containing the dispersing agent, a third aqueous solution containing the thickener, and the waste foundry sand. Based on 100 wt % of the first aqueous solution, the binder is present in an amount of less than 25 wt %. Based on 100 wt % of the second aqueous solution, the dispersing agent is present in an amount of less than 1 wt %. Based on 100 wt % of the third aqueous solution, the thickener is present in an amount of less than 1 wt %. By virtue of the waste foundry sand being present in the amount ranging from 40 wt % to 60 wt % based on 100 wt % of the slurry, the slurry prepared as described above may have a viscosity of less than 2000 cps at 25° C.

In some embodiments, the granulation may be centrifugal spray granulation or kneading granulation. When the slurry is subjected to the centrifugal spray granulation, the solid granules thus formed tend to be more spherical in shape. In still some embodiments, each of the solid granules may have a particle size ranging from 30 μm to 50 μm, and the solid granules with such particle size can be more easily converted into the hollow spheres of the present disclosure in the subsequent steps.

In other embodiments, each of the solid granules may include the zirconium dioxide present in an amount ranging from 1 wt % to 10 wt %, the silicon dioxide present in an amount ranging from 60 wt % to 75 wt %, and the aluminium oxide present in an amount ranging from 15 wt % to 30 wt %. In still other embodiments, each of the solid granules may include the zirconium dioxide present in an amount ranging from 1 wt % to 10 wt %, the silicon dioxide present in an amount ranging from 60 wt % to 75 wt %, the aluminium oxide present in an amount ranging from 15 wt % to 30 wt %, and the other metal oxide(s) present in an amount ranging from 5 wt % to 10 wt %. It is to be understood that the zirconium dioxide, the silicon dioxide, the aluminium oxide and the other metal oxide(s) contained in each of the solid granules are substantially derived from the waste foundry sand.

According to the present disclosure, each of the hollow spheres has the ceramic shell that contains the mullite, the zircon, the cristobalite, the quartz, the monoclinic zirconium dioxide (m-ZrO₂), and the tetragonal zirconium dioxide (t-ZrO₂) that are originated from the waste foundry sand. The monoclinic zirconium dioxide and the tetragonal zirconium dioxide present in the hollow spheres were formed from the zirconium dioxide in the solid granules as a result of the temperature change during the heat treatment. The aim of the present disclosure is directed to manufacture of the hollow spheres with an improved high-temperature resistance, thereby allowing the hollow spheres to be particularly suitable for use as a high-temperature resistant material. Accordingly, the purpose of the present disclosure is to form the tetragonal zirconium dioxide within the hollow spheres. However, it can be understood that, due to processing conditions, except for the monoclinic zirconium dioxide, in some embodiments, cubic zirconium dioxide may also be incidentally formed within the hollow spheres.

In some embodiments, the heat treatment may be performed using an oxyacetylene flame that has a temperature ranging from 1500° C. to 3000° C.

The method for manufacturing the hollow spheres from the waste foundry sand according to the present disclosure successfully converts the waste foundry sand into the hollow spheres with higher value. In addition, the hollow spheres contain the tetragonal zirconium dioxide, and hence are resistant to high temperatures.

The present disclosure also provides a hollow sphere, which is manufactured by the aforesaid method. The hollow sphere includes the silicon dioxide present in the amount ranging from 60 wt % to 75 wt %, the aluminium oxide present in the amount ranging from 15 wt % to 30 wt %, and the zirconium dioxide present in the amount ranging from 1 wt % to 10 wt %. Specifically, the silicon dioxide exists in the mullite, the cristobalite and the quartz, the aluminium oxide exists in the mullite, and the zirconium dioxide exists in the monoclinic zirconium dioxide and the tetragonal zirconium dioxide.

According to the present disclosure, the hollow sphere has the ceramic shell. In some embodiments, the ceramic shell may have a thickness ranging from 2 μm to 20 μm.

In some embodiments, the hollow sphere may have a particle size ranging from 65 μm to 120μ m.

The disclosure will be further described by way of the following example. However, it should be understood that the following example is solely intended for the purpose of illustration and should not be construed as limiting the disclosure in practice.

### EXAMPLE

### Preparation of Hollow Spheres

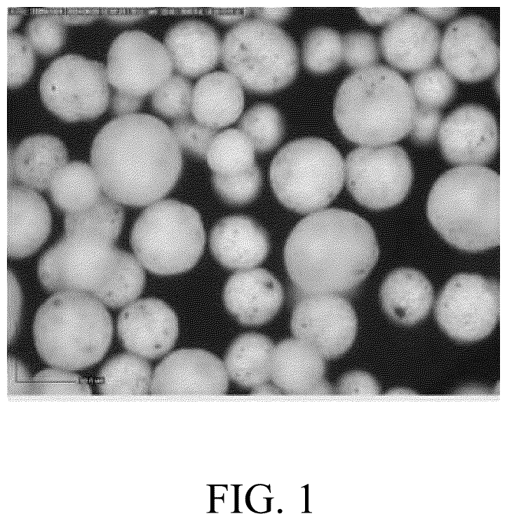

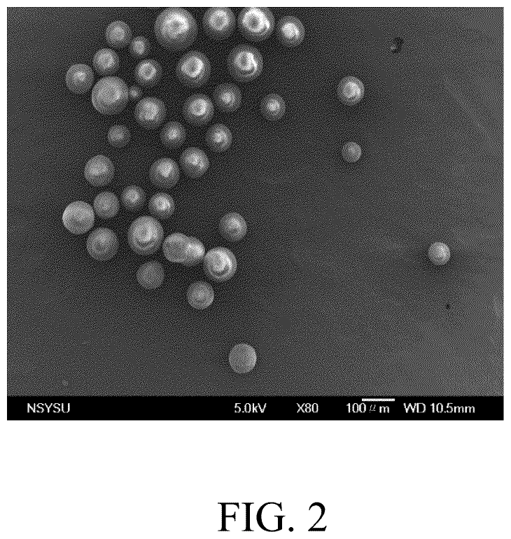

42.5 wt % of a waste foundry sand (derived from a discarded ceramic shell mold; having an average particle size ranging from 5 μm to 40 μm), 23.3 wt % of a first aqueous solution (composed of 13.9 wt % of a silica gel, which served as a binder, and 86.1 wt % of water), 1.0 wt % of a second aqueous solution (composed of 0.8 wt % of an aqueous dispersing agent (i.e., Dispex® Ultra CX 4452 manufactured by Badische Anilin-und-Soda-Fabrik (BASF), which served as a dispersing agent, and 99.2 wt % of water), 30.0 wt % of a third aqueous solution (composed of 0.3 wt % of methylcellulose, which served as a thickener, and 99.7 wt % of water), and 3.2 wt % of water were mixed to form a slurry. The slurry was subjected to measurement of viscosity using a rheometer (Anton Paar; Model: RHEOPLUS/32), and was found to have a viscosity of 325 cps at 25° C. Thereafter, the slurry was subjected to centrifugal spray granulation, in which centrifugal force was used to fling the slurry into a plurality of spherical droplets. After that, the spherical droplets were dried and sieved to obtain a plurality of solid granules, which were then subjected to measurement of particle size using an electronic digital measuring microscope (Argus Microscope; 48 million pixels). The thus measured particle size of each of the solid granules ranged from 30 μm to 50 μm. In addition, the solid granules were photographed using the electronic digital measuring microscope, thereby obtaining an optical microscope (OM) image thereof as shown in FIG. 1. The solid granules were also subjected to imaging using a field emission scanning electron microscope (SEM) (JEOL; Model: JSM-6330TF), thereby obtaining an SEM image thereof as shown in FIG. 2.

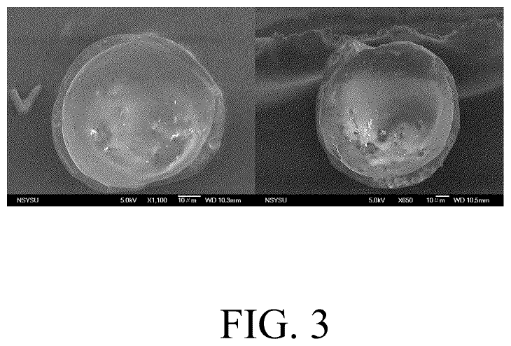

Subsequently, the solid granules were subjected to a heat treatment by spraying the same with an oxyacetylene flame that had a temperature ranging from 2500° C. to 3000° C., followed by cooling, thereby converting the solid granules into a plurality of hollow spheres. The hollow spheres were subjected to measurement of particle size using a particle size analyzer (Anton Paar; Model: 990). The thus measured particle size of each of the hollow spheres ranged from 65 μm to 120 μm. The hollow spheres were also subjected to imaging using the field emission SEM, thereby obtaining an SEM image thereof as shown in FIG. 3. In addition, each of the hollow spheres had a ceramic shell having a thickness ranging from 2 μm to 20 μm, as measured after being subjected to the aforesaid imaging.

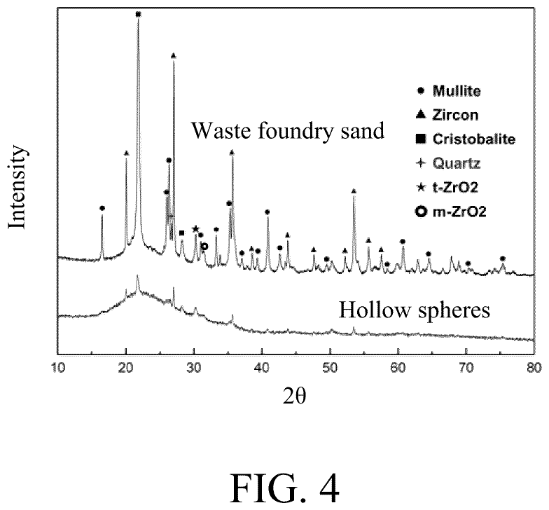

Moreover, a respective one of the waste foundry sand and the solid granules was subjected to analysis of ingredients using an X-ray diffractometer (Rigaku; Model: MiniFlex 600), and the results were shown in the Table below. Furthermore, each of the waste foundry sand and the hollow spheres was also subjected to analysis of ingredients using the X-ray diffractometer, thereby obtaining an X-ray diffraction pattern of the same as shown in FIG. 4.

TABLE

| | | Waste foundry sand | Solid granules |
|---|---|---|---|
| Ingredients | SiO₂ | 60.8 | 72.4 |
| (wt %) | Al₂O₃ | 25.3 | 16.1 |
| | ZrO₂ | 8.60 | 6.09 |
| | Fe₂O₃ | 1.56 | 1.35 |
| | TiO₂ | 1.35 | 1.18 |
| | Na₂O | 0.411 | 1.02 |
| | CaO | 0.400 | 0.358 |
| | P₂O₅ | 0.292 | 0.264 |
| | MoO₃ | 0.265 | 0.274 |
| | K₂O | 0.221 | 0.179 |
| | HfO₂ | 0.207 | 0.177 |
| | MgO | 0.204 | 0.160 |
| | Cr₂O₃ | 0.130 | 0.101 |
| | Other metal oxide(s) | 0.26 | 0.347 |

In summary, the method for manufacturing the hollow spheres of the present disclosure not only enables sustainable reuse of the waste foundry sand but also allows the waste foundry sand to be converted into a product with higher economic value, i.e., the hollow spheres. In addition, manufacturing cost of the hollow spheres is low when the waste foundry sand is used as a raw material. Furthermore, the hollow spheres produced from the waste foundry sand according to the method of the present disclosure have a strength comparable to that of conventional glass hollow spheres. Specifically, the presence of the tetragonal zirconium dioxide in the hollow spheres enables the hollow spheres to withstand high temperatures, making them suitable for application in various technical fields, such as construction, installation, operation and maintenance of an offshore wind farm, refractory materials, and aerospace technology. Accordingly, the method of the present disclosure successfully converts the waste foundry sand into the hollow spheres which have broader applications and higher value, thereby achieving the purpose of the present disclosure.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for manufacturing hollow spheres, comprising:
mixing water, a slurry component including a binder, and a waste foundry sand including silicon dioxide, aluminium oxide and zirconium dioxide to form a slurry, the waste foundry sand being present in an amount ranging from 40 wt % to 60 wt % based on 100 wt % of the slurry;
subjecting the slurry to granulation, so that the slurry is formed into solid granules; and
subjecting the solid granules to a heat treatment, followed by cooling, so as to allow the solid granules to undergo a thermochemical reaction and to be converted into the hollow spheres, each of the hollow spheres having a ceramic shell that contains tetragonal zirconium dioxide.

2. The method as claimed in claim 1, wherein based on 100 wt % of the waste foundry sand, the zirconium dioxide is present in an amount ranging from 1 wt % to 10 wt %, the silicon dioxide is present in an amount ranging from 50 wt % to 70 wt %, and the aluminium oxide is present in an amount ranging from 20 wt % to 40 wt %.

3. The method as claimed in claim 1, wherein the binder is selected from the group consisting of a silica gel, a silicone resin, and a combination thereof.

4. The method as claimed in claim 1, wherein the granulation is centrifugal spray granulation or kneading granulation.

5. The method as claimed in claim 1, wherein each of the solid granules has a particle size ranging from 30 μm to 50 μm.

6. The method as claimed in claim 1, wherein each of the solid granules includes the zirconium dioxide present in an amount ranging from 1 wt % to 10 wt %, the silicon dioxide present in an amount ranging from 60 wt % to 75 wt %, and the aluminium oxide present in an amount ranging from 15 wt % to 30 wt %.

7. The method as claimed in claim 1, wherein the heat treatment is performed using an oxyacetylene flame that has a temperature ranging from 1500° C. to 3000° C.

8. A hollow sphere, which is manufactured by the method as claimed in claim 1, comprising the silicon dioxide present in an amount ranging from 60 wt % to 75 wt %, the aluminium oxide present in an amount ranging from 15 wt % to 30 wt %, and the zirconium dioxide present in an amount ranging from 1 wt % to 10 wt %, the hollow sphere having the ceramic shell that contains the tetragonal zirconium dioxide.

9. The hollow sphere as claimed in claim 8, wherein the ceramic shell has a thickness ranging from 2 μm to 20 μm.

10. The hollow sphere as claimed in claim 8, which has a particle size ranging from 65 μm to 120 μm.
